(19) United States
(12) Patent Application Publication
(10) Pub. No.: US 2016/0224985 A1
(43) Pub. Date: Aug. 4, 2016

(54) SYSTEM AND METHOD FOR CARD PAYMENT IN WHICH CONFIRMATION IS AVAILABLE BEFORE TRANSACTION

(71) Applicant: KOUNOSOFT CO., LTD., Seoul (KR)

(72) Inventors: Jang Gwan JO, Namyangju (KR); Haekoong JUNG, Seoul (KR); Seok Bae PARK, Seoul (KR)

(21) Appl. No.: 14/854,156

(22) Filed: Sep. 15, 2015

(30) Foreign Application Priority Data
Jan. 30, 2015 (KR) 10-2015-0015455

(51) Int. Cl. G06Q 20/42; G06Q 20/32; G06Q 20/38; G06Q 20/40; G06Q 20/34

(52) U.S. Cl. CPC G06Q 20/425; G06Q 20/409; G06Q 20/351; G06Q 20/354; G06Q 20/3829; G06Q 20/3278; G06Q 2220/00

(57) ABSTRACT

A method of paying by a before-transaction confirmation card includes: receiving, by a payment service server, a user's payment information approval request from an affiliated store terminal; requesting, by the payment service server, transaction confirmation from a before-transaction confirmation server; performing, by the before-transaction confirmation server, a transaction confirmation signature after confirmation for a transaction confirmation request; and approving, by the payment service server, a user transaction in the affiliated store terminal.

### CROSS-REFERENCE TO RELATED APPLICATION

This application claims priority to and the benefit of Korean Patent Application No. 10-2015-0015455 filed in the Korean Intellectual Property Office on Jan. 30, 2015, the entire contents of which are incorporated herein by reference.

### BACKGROUND OF THE INVENTION

(a) Field of the Invention

The present invention relates to a system and method for card payment in which confirmation is available before a transaction. More particularly, the present invention relates to a system and method for card payment in which confirmation is available before a transaction that can reduce a holding time for identifying a user upon a transaction and that can use a credit card without worry about illegal use regardless of online or offline.

(b) Description of the Related Art

Mobile payment merits in that it can be used at any time and place, it can provide a user with a convenient service based on a location, and it can be performed with a customized method according to a user need and request.

However, due to a drawback of an inconvenient procedure that installs various plug-ins such as ActiveX and a keyboard security program or that it should input payment information every time, mobile payment is abandoned during payment or due to a security problem, so mobile payment is not universally used.

In order to solve such problems, a universal subscriber identity module (USIM) type of mobile card has been used.

When approaching a payment terminal that is provided at an affiliated store, the USIM type of mobile card has a merit that payment is performed, but has drawbacks that for a payment service, a chip should be separately issued, a corresponding service can be used by registering only one payment means, and at a store, a service may be used only when a related infrastructure is provided.

Currently, an application (App) type of mobile card has been developed and may be used at online and offline affiliated stores by registering an existing card (credit/check/advance payment) in a mobile user terminal application without a separate issue procedure, unlike an existing method of storing card information within a USIM.

A payment method using an App type of mobile card may be used by partially adjusting only software of currently used payment terminal without the necessity of installing an additional apparatus at a store, but upon payment, an application should be driven, and due to insufficient offline affiliated stores, a case in which payment is not appropriately performed frequently occurs.

In order to simplify complexity of such payment, methods have been suggested in which payment is performed when contacting a payment means with an affiliated store terminal using near field communication technology, in which simple payment is performed using a mobile electronic wallet App, in which simple payment is performed with only ID of a portal site, or in which mobile payment is performed with only an input of a previously registered payment password when subscribing a service through connection with a domestic messenger.

However, the simple payment services may be used only in a specific terminal like the foregoing USIM card or App type of card, but due to an insufficient payment infrastructure, the simple payment services may be limitedly used for a specific affiliated store and a specific card or may be used for a specific open market or mobile shopping mall but cannot be universally used.

Further, when performing a confirmation process before online/offline payment of a mobile card, a user should directly manually input a password, and upon payment, and for a personal identification work between a payment service server and an affiliated store terminal, there is a problem that much holding time is consumed.

Further, upon payment, much holding time for confirmation is consumed, and while communicating with a banking institution, a private key may be attacked, an illegal intermediary attack may occur, and transaction data may be modulated.

That is, when card payment is performed without a particular separate procedure or when payment is performed by signing on an input screen of an affiliated store terminal without a personal identification process off line, a problem according to illegal card use may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for card payment in which confirmation is available before a transaction having advantages of being capable of using a basic credit card infrastructure without addition of a separate apparatus or separate partnership, having universality that can be applied to a newly developed App type of mobile card or other several simple payment services, and simultaneously satisfying security and convenience.

The present invention has been made in an effort to further provide a system and method for card payment in which confirmation is available before a transaction having advantages of being capable of preventing worry about a lost card of card users while enabling a smooth transaction to occur by previously removing worry about a holding time for user identification.

An exemplary embodiment of the present invention provides a card payment system in which confirmation is available before a transaction, including: a payment service server that stores virtual payment card issue information, that issues a payment card corresponding to the virtual payment card, and that receives and approves payment request information of the payment card from an affiliated store terminal; and a before-transaction confirmation server that supports before-transaction confirmation using the virtual payment card before a transaction of the payment card.

Another embodiment of the present invention provides a method of paying by a card in which confirmation is available before a transaction, including: receiving, by a payment service server, a user's payment information approval request from an affiliated store terminal; requesting, by the payment service server, transaction confirmation to a before-transaction confirmation server; performing, by the before-transaction confirmation server, a transaction confirmation signature after confirmation of a transaction confirmation request; and approving, by the payment service server, a user transaction in the affiliated store terminal.

In an exemplary embodiment of the present invention, before a card transaction, by preliminarily approving a transaction and performing a card transaction, a card user can perform a transaction with safe card approval.

In an exemplary embodiment of the present invention, an existing before-transaction confirmation method is a method of performing personal identification while performing card payment, but a method of the present invention is a method of previously registering preliminary approval before a card transaction, and when performing payment with an existing method, by previously removing worry about a holding time that may occur, a smooth transaction may occur, there is an additional effect of preventing worry about a lost card of card users.

In an exemplary embodiment of the present invention, a safe card transaction can be performed using a smart communication terminal and a security area.

In an exemplary embodiment of the present invention, by performing authentication before a transaction, when smishing occurs and card information is discharged, safety of a transaction can be secured.

In an exemplary embodiment of the present invention, by applying to separate various services such as use of a safe and automatic payment through authentication technology before a transaction, a safe cannot be used without approval of a subscriber or a transaction cannot be performed, and thus a safer service can be provided.

### BRIEF DESCRIPTION OF THE DRAWINGS

FIG. 1 is a schematic diagram illustrating a before-transaction confirmation card payment system according to an exemplary embodiment of the present invention.

FIG. 2 is a block diagram illustrating a detailed configuration of a user terminal and a before-transaction confirmation server of a before-transaction confirmation card payment system according to an exemplary embodiment of the present invention.

FIGS. 3A to 3C are diagrams illustrating an initial authentication screen of a before-transaction confirmation card payment service application driving in a user terminal of a before-transaction confirmation card payment system according to an exemplary embodiment of the present invention.

FIGS. 4A and 4B are diagrams illustrating a card registration screen of a before-transaction confirmation card payment service application driving in a user terminal of a before-transaction confirmation card payment system according to an exemplary embodiment of the present invention.

FIGS. 5A and 5B are operation flowcharts illustrating key exchange in a subscription procedure of a before-transaction confirmation card payment system according to an exemplary embodiment of the present invention.

FIG. 6 is a diagram illustrating a before-transaction approval application screen of a user terminal of a before-transaction confirmation card payment system according to an exemplary embodiment of the present invention.

FIG. 7 is a diagram illustrating a relationship with another user terminal or near field communication (NFC) that is interlocked with a user terminal of a before-transaction confirmation card payment system according to an exemplary embodiment of the present invention.

FIG. 8 is a schematic diagram illustrating a before-transaction confirmation card payment system according to another exemplary embodiment of the present invention.

FIG. 9 is an operation flowchart illustrating a payment method of a before-transaction confirmation card according to another exemplary embodiment of the present invention.

FIGS. 10A to 10C are diagrams illustrating a preliminary approval service application screen of a before-transaction confirmation card payment system according to another exemplary embodiment of the present invention.

FIG. 11 is an operation flowchart illustrating a key exchange method between a user terminal and a before-transaction confirmation server of a before-transaction confirmation card payment system according to another exemplary embodiment of the present invention.

FIG. 12 is a schematic diagram illustrating a security policy according to a key exchange method of a before-transaction confirmation card payment system according to another exemplary embodiment of the present invention.

### DETAILED DESCRIPTION OF THE EMBODIMENTS

The present invention may be variously changed and have several exemplary embodiments, and herein, specific exemplary embodiments are illustrated in the drawings and a detailed content for executing the invention is described in detail.

While the present invention may be embodied in many different forms, specific embodiments of the present invention are shown in the drawings and are described herein in detail with the understanding that the embodiments of the present invention are to be considered as exemplary of the principles of the invention and are not intended to limit the invention to the specific illustrated embodiments.

Terms such as first, second, A, and B may be used for describing various constituent elements, but the constituent elements are not limited by the terms. The terms are used for distinguishing one constituent element from another constituent element.

For example, a first constituent element may be referred to as a second constituent element without deviating from the scope of the present invention, and similarly, a second constituent element may be referred to as a first constituent element. A term “and/or” includes a combination of a plurality of related described elements or any element of a plurality of related described elements.

When it is described that a constituent element is “connected” or “electrically connected” to another constituent element, the element may be “directly connected” or “directly electrically connected” to the other constituent elements, or may be “connected” or “electrically connected” to the other constituent elements through a third element.

However, when it is described that a constituent element is “directly connected” or “directly electrically connected” to another constituent element, no element may exist between the element and the other constituent elements.

Terms used in the present application are for describing a specific exemplary embodiment and do not limit the present invention. When used in a description of the present application and the appended claims, a singular expression includes a plurality of expressions unless explicitly differently represented.

Further, in the present application, a term “comprise” or “have” indicates presence of a characteristic, a numeral, a step, an operation, an element, a component, or a combination thereof described in the specification, and does not exclude presence or addition of at least another characteristic, numeral, step, operation, element, component, or combination thereof.

Unless differently defined, all terms used herein including technical or scientific terms have the same meaning as that which may be generally understood by a person of common skill in the art.

It should be interpreted that terms defined in a generally used dictionary have meanings corresponding to those of a context of related technology, and are not to be interpreted as having idealized or excessively formal meanings unless explicitly defined to the contrary.

Hereinafter, exemplary embodiments of the present invention will be described in detail with reference to the accompanying drawings.

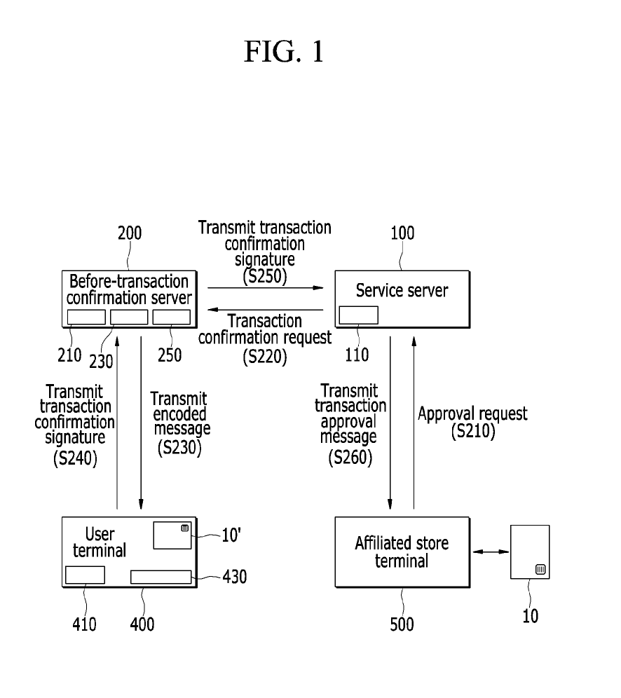

FIG. 1 is a schematic diagram illustrating a before-transaction confirmation card payment system according to an exemplary embodiment of the present invention.

Referring to FIG. 1, a before-transaction confirmation card payment system according to an exemplary embodiment of the present invention includes a payment service server 100 that issues a payment card to a user and that performs payment processing, a before-transaction confirmation server 200 that prescribes the user's transaction available state before performing payment processing of the payment service server 100, a user terminal 400 that uses a payment card 10 as a before-transaction confirmation payment card 10′, and an affiliated store terminal 500.

The payment service server 100 includes first to n-th payment service servers 100-1, 100-2, . . . , 100-n. That is, in an exemplary embodiment of the present invention, a plurality of payment service servers may together provide a before-transaction confirmation card payment process.

A user of the user terminal 400 may perform payment with a plurality of payment service servers through one before-transaction confirmation payment service server without downward and installation of different card payment exclusive programs from an App on each payment service server basis.

The payment card 10 may be a unique plastic card, or may be a mobile card that provides payment using the user terminal 400 by registering an existing plastic card.

In this case, the user terminal 400 may support an App card payment method such as a bar code, a quick response (QR) code, NFC, and a direct input, unlike an existing USIM mobile card that is limited to only an NFC phone.

Although not particularly limited, in an exemplary embodiment of the present invention, it is assumed that the user terminal 400 supports a plastic payment card 10 that performs payment by contacting an existing IC chip or magnetic card with the affiliated store terminal 500 using a before-transaction confirmation payment card that is stored thereto.

In such a case, while activating an App type of mobile card, a selected customized App type of mobile card may be used according to a coupon or a discount rate that the payment service server 100 provides, and a separate affiliated store terminal 500 may be used, or other different existing infrastructures may be used.

The before-transaction confirmation server 200 is communication-connected to the user terminal 400 and each of a plurality of payment service servers 300-1, 300-2, . . . 300-n through a communication network, and enables payment between the payment card 10 and the respective payment service servers 300-1, 300-2, . . . 300-n to individually confirm before transaction through the user terminal 400 using the before-transaction confirmation payment card 10′ of the user terminal 400.

To this end, the payment service server 100 may include a member register 110 that registers a before-transaction confirmation payment card member by transmitting a URL text in which a unique identification code is given, a security management unit 120 that registers a before-transaction confirmation virtual payment card to the user terminal 400 of the before-transaction confirmation payment card member and that generates a unique security code, a payment request receiving unit 140 that receives a payment request full text of the payment card 10 in the affiliated store terminal 500, a payment approval unit 150 that approves the payment request full text, a before-transaction confirmation request unit 160 that requests a transaction available state before payment approval of the payment approval unit 150 to the before-transaction confirmation server 200, and a before-transaction confirmation receiving unit 170 that receives before-transaction confirmation of the before-transaction confirmation server 200.

The before-transaction confirmation server 200 encodes a transaction request full text from the payment service server 100 before the payment service server 100 or a van company server approves a transaction in the affiliated store terminal 500 with a generated first key (a random key, a session key), and transmits the full text to the user terminal 400.

The user terminal 400 confirms the first key that is included in an encoded message that is received from the before-transaction confirmation server 200 using a before-transaction confirmation program or application and a second key, which is a security key that is stored at a security area 410 of the user terminal 400, displays a message that the transaction request is received in a display unit 430 thereof so as to show it to the user by coupling the first key and the second key, receives an input of a transaction confirmation signature of the user, and transmits the transaction confirmation signature to the before-transaction confirmation server 200.

For this purpose, the before-transaction confirmation server 200 may include a first key receiving unit 210 that receives Key1 from the payment card 10, a second key receiving unit 220 that receives Key2 from security areas 410, 610, and 810 of the user terminal 400, a wearable device 600 or an accessory device 800 that performs near field wireless communication with the user terminal 400, and a before-transaction confirmation unit 230 that performs before-transaction confirmation by coupling of the Key1 and the Key2.

Further, the before-transaction confirmation server 200 may include an encoded message generator 240 that encodes a transaction full text that is transmitted from the payment service server 100 using the Key1, a decoding unit 250 that decodes the encoded message using the Key2, a before-transaction confirmation signature unit 260 that confirms a transaction detail that is decoded in the decoding unit 250 and that performs before-transaction confirmation signature, and an illegal transaction receiving unit 270 that receives an illegal transaction report of a stolen or lost payment card.

The user terminal 400 stores and maintains at least one program code (e.g., a program code that is connected to an App payment exclusive program) that is executed through a controller 450 and at least one data set that is used by the program code at a memory 470.

The memory 470 may generally store a system program code and a system data set corresponding to an operation system (e.g., an OS for an iPhone, an OS for an Android) of the user terminal 400, and a communication program code and a communication data set and at least one application program code and application data set that process wireless communication connection of the user terminal 400.

According to an exemplary embodiment of the present invention, the controller 450 of the user terminal 400 controls a “mobile (simple payment) card registration process” and a “payment processing process” according to a payment method of a payment card for supporting a before-transaction confirmation card payment method, and controls to display the process in the display unit 430.

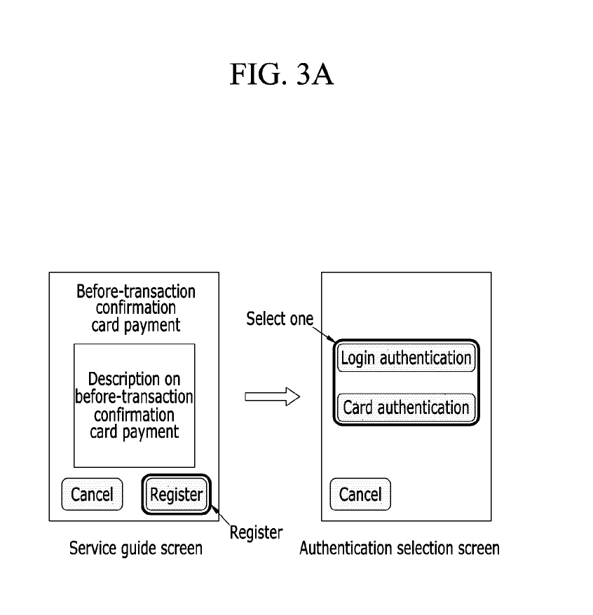

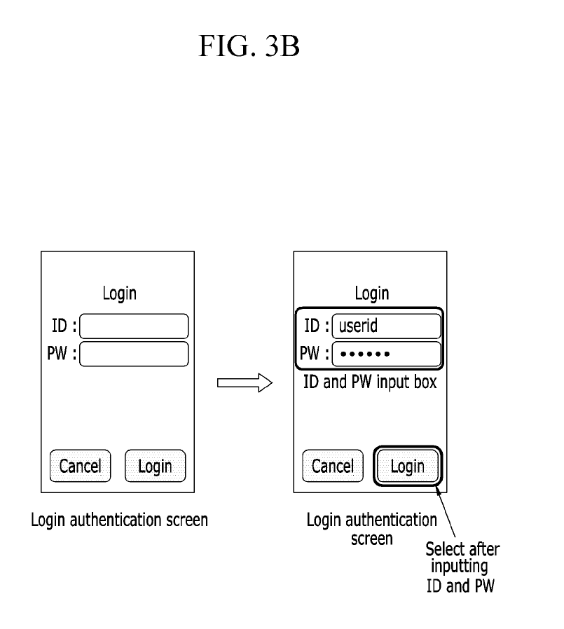

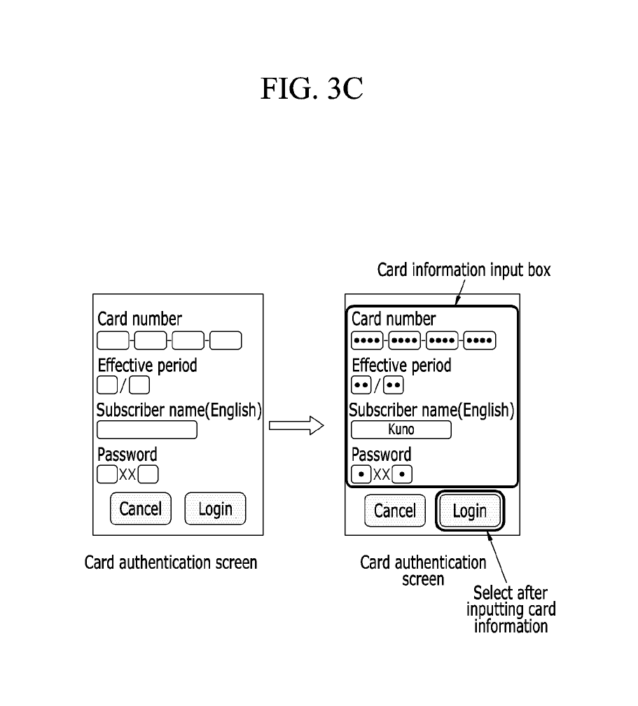

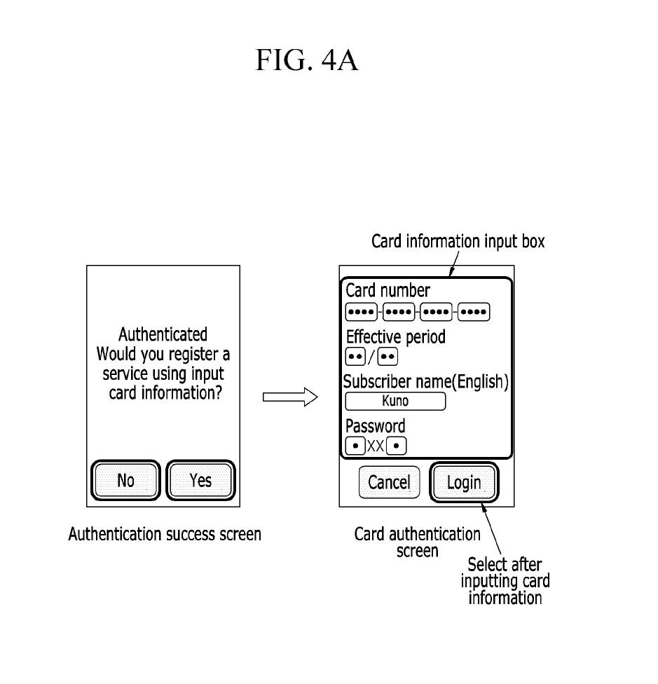

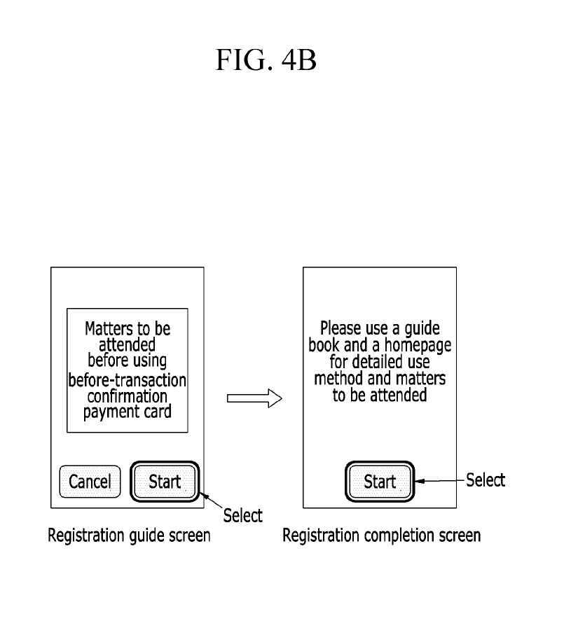

Hereinafter, an “authentication process for subscribing to a before-transaction confirmation card payment service member” will be described in detail with reference to FIGS. 3A to 3C, and a “payment processing process according to a registered App card will be described in detail with reference to FIG. 4A.

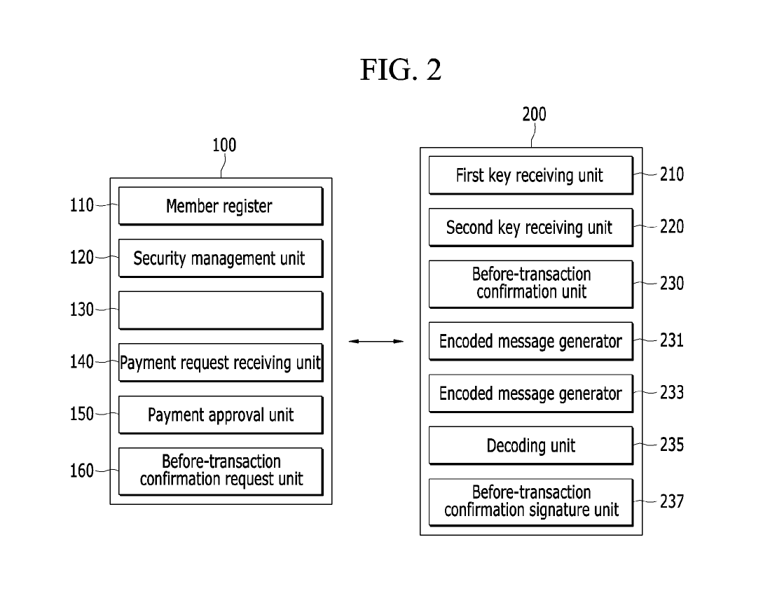

FIGS. 3A to 3C are diagrams illustrating a card registration screen of a before-transaction confirmation card payment service application driving in a user terminal of a before-transaction confirmation card payment system according to an exemplary embodiment of the present invention, and for better understanding of the description, the card registration screen will be described with reference to FIGS. 3A to 3C together with FIGS. 1 and 2.

First, the user terminal 400 downloads and installs a before-transaction confirmation card payment exclusive program (hereinafter referred to as a ‘before-transaction confirmation payment exclusive App’) that a plurality of payment service servers 100-1, 100-2, . . . 100-n distribute together through an App store through a program or an application that the before-transaction confirmation server 200 provides.

As shown in FIG. 3A, the user terminal 400 may provide a before-transaction confirmation card payment service guide screen, as shown in FIG. 3B, the user terminal 400 may provide a login authentication screen according to a user input manipulation to enable to perform login authentication using an ID and a password, and as shown in FIG. 3C, the user terminal 400 may enable card authentication.

As shown in FIG. 4A, when authentication has succeeded, card registration may be performed using card registration information that is used for authentication, and in another case, a card registration screen is provided, an input of card registration information is received according to a user input manipulation, and the card registration information is transmitted to the before-transaction confirmation server 200.

As shown in FIG. 4B, the user terminal 400 may provide a card registration guide screen to be used for a before-transaction confirmation card payment service and complete card registration according to user confirmation.

Specifically, in an installed before-transaction confirmation payment exclusive App, when a user's login or card authentication has succeeded, the user terminal 400 uses card information that is used for authentication according to a user selection or displays an interface requiring an input of card registration information necessary for registering another card in the display unit 430 through an execution screen, inputs card registration information through the user key input or touch input, transmits the input card registration information to the before-transaction confirmation server 200, and the before-transaction confirmation server 200 transmits the input card registration information to the payment service server 100.

Here, the card registration information includes at least one of user information and multiple card information that is connected to the user information. The user information includes a user's social security number, a user's mobile number, and the like, and the card information includes at least one of a card number such as 16 digit number, an effective period, a card validation code (CVC) code, a password, and a payment password of each card.

The before-transaction confirmation server 200 registers cards that a user requests to register to an App based on card registration information that is received from the user terminal 400, and simultaneously transmits benefit information and event information on a card basis to the terminal. The payment service server 100 may perform a process of registering cards that request registration to an App.

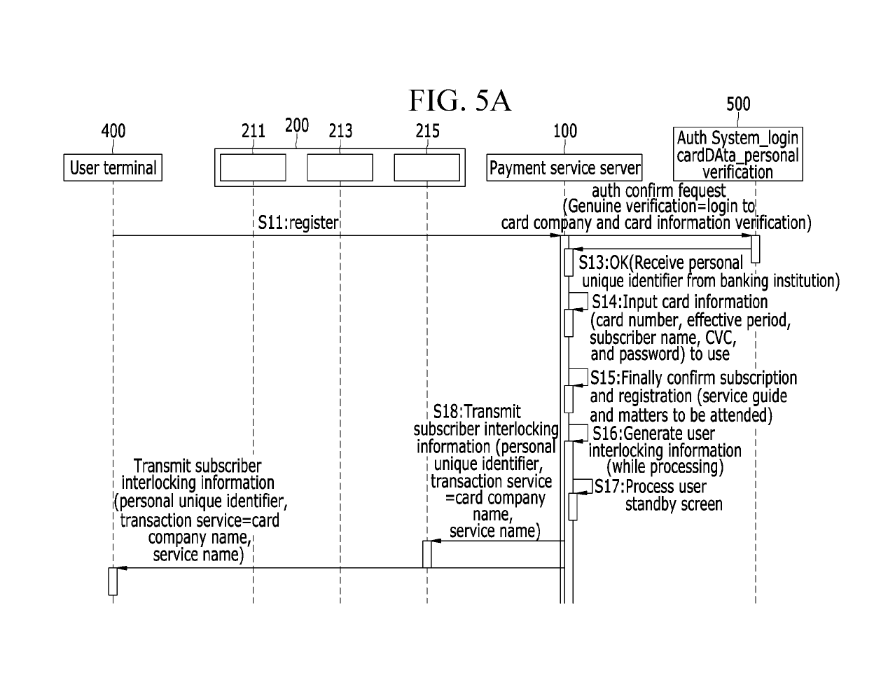

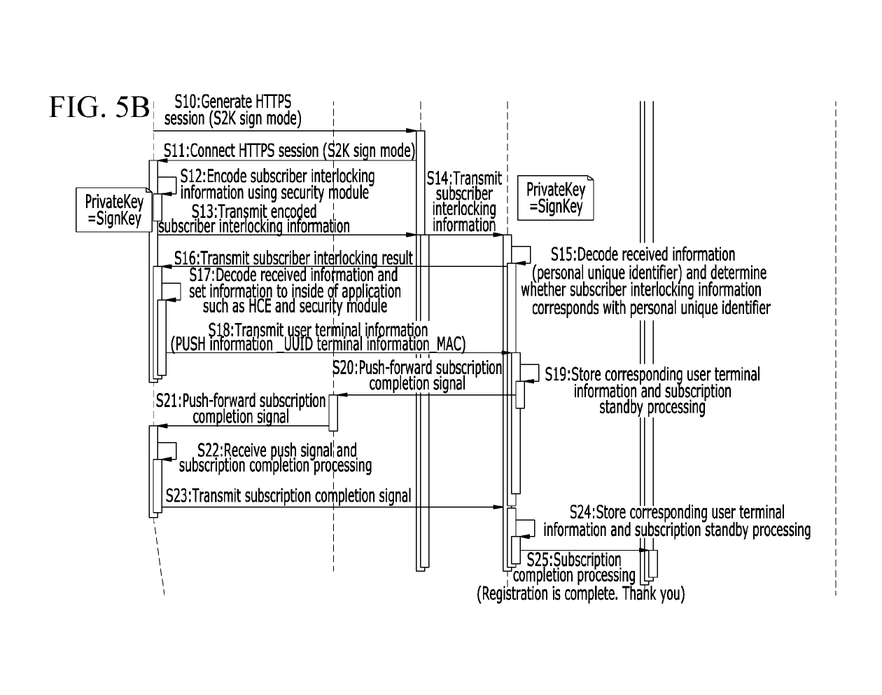

FIGS. 5A and 5B are operation flowcharts illustrating key exchange in a subscription procedure of a before-transaction confirmation card payment system according to an exemplary embodiment of the present invention.

The user terminal 400 requests before-transaction confirmation card payment service subscription card registration from the payment service server 100 through a before-transaction confirmation card payment service application (S511).

The payment service server 100 requests personal authentication from an authentication system 900 using login information and card information (S512).

When authentication is performed through the authentication system 900, the payment service server 100 provides a personal unique identifier (S513) and enables to input card information, i.e., a card number, an effective period, a subscriber name, a CVC, and a password to use for a before-transaction confirmation card payment service (S514).

The payment service server 100 finally confirms the before-transaction confirmation card payment service subscription and registration of a card to use together with a service guide and matters to be attended to (S515).

The payment service server 100 generates user interlocking information that is interlocked with a before-transaction confirmation payment service (S516), and processes a user standby screen for a user interlocking information generation time (S517).

When the payment service server 100 transmits the generated subscriber interlocking information (personal unique identifier, transaction service=card company name, service name) to the before-transaction confirmation server 200 (S518), the before-transaction confirmation server 200 transmits the subscriber interlocking information including a personal unique identifier to the user terminal 400 (S519).

When the user terminal 400 generates HTTPS session and transmits the HTTPS session to the before-transaction confirmation server 200 (S10), the before-transaction confirmation server 200 connects the HTTPS session between the before-transaction confirmation server 200 and the user terminal 400 (S11).

The user terminal 400 encodes subscriber interlocking information using SignKey of a security element 410 (S12).

When the user terminal 400 transmits the encoded subscriber interlocking information to the before-transaction confirmation server 200 (S13), the before-transaction confirmation server 200 decodes the personal unique identifier that is transmitted from the payment service server 100 using the received SignKey and determines whether the subscriber interlocking information corresponds with the personal unique identifier (S15).

When the before-transaction confirmation server 200 transmits a subscriber interlocking result to the user terminal 400 (S16), the user terminal 400 decodes the received information and sets the information to the inside of a before-transaction confirmation card payment service application such as HCE and a security module (S17).

The user terminal 400 transmits user terminal information such as PUSH UUID, a terminal kind (OS), a personal unique identifier, user information (registration ID), and registration card company information to the before-transaction server 200 (S18).

Thereby, upon initial subscription, a unique identifier between the user terminal 400 and the payment service server 100 is notified to the before-transaction confirmation server 200.

When UUID exists within transaction information of the payment service server 100, user information may not be transmitted.

While the before-transaction confirmation server 200 stores corresponding user terminal information and user information, a subscription standby processing is performed (S19).

The before-transaction confirmation server 200 push-forwards a subscription completion signal to the user terminal 400 (S20), and after the push signal is received, when the user terminal 400 performs subscription completion processing (S22) and transmits the subscription completion signal to the before-transaction confirmation server 200 (S23), the before-transaction confirmation server 200 converts a state of a corresponding user from a subscription standby state to a subscription completion state and performs subscription completion processing (S25).

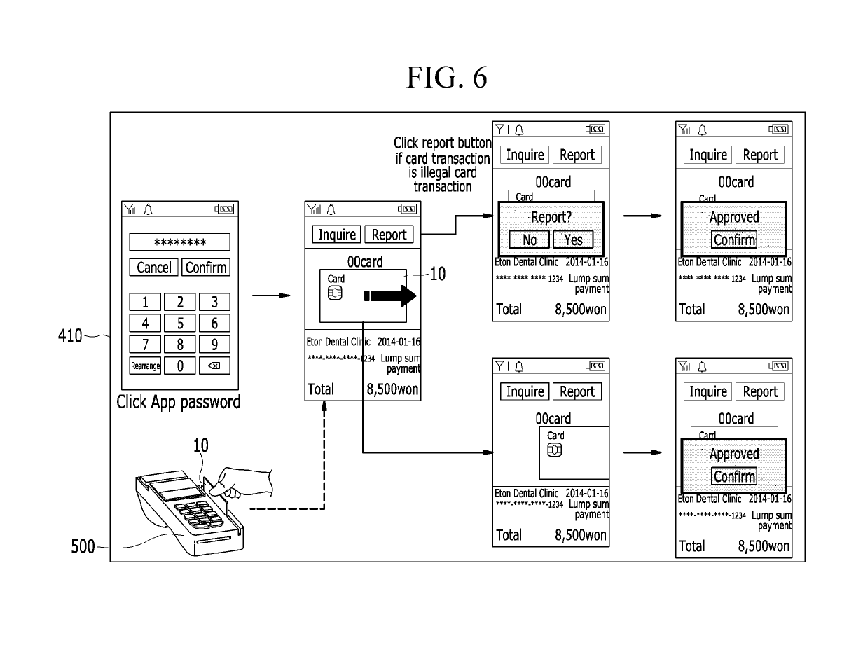

FIG. 6 is a diagram illustrating a before-transaction approval application screen of a user terminal of a before-transaction confirmation card payment system according to an exemplary embodiment of the present invention.

FIG. 6 illustrates a process in which a customer pays by a credit card offline, and by using and signing a credit card in an affiliated store terminal 500 (PointofSale (POS)), card payment is performed.

Thereafter, the affiliated store terminal 500 transmits a transaction approval request and customer signature data to the payment service server 100 (S210).

Thereafter, the payment service server 100 transmits a transaction confirmation request message to the before-transaction confirmation server 200 (S220).

Thereafter, the before-transaction confirmation server 200 generates Key1 and transmits the Key1 to the user terminal 400 of a customer (S230).

Thereafter, the user terminal 400 of the customer decodes the Key1 and exposes an approval confirmation message to the customer using Key2 that is acquired from a secure element (SE) that is stored in a security area such as an internal universal subscriber identity module (USIM).

The user confirms the exposed approval confirmation message and signs transaction confirmation.

In this case, as shown in FIG. 6, when the approval confirmation message corresponds to payment content, by sliding a virtual payment card in one direction, the user confirms payment, and when the approval confirmation message does not correspond to payment content, by sliding a virtual payment card in an opposite direction, the user may reject payment, while when the transaction is an illegal transaction, the user may report this to the before-transaction confirmation server 200 using a report button.

When the approval confirmation message corresponds to payment content, the user selects confirmation and the user terminal 400 transmits a transaction confirmation signature to the before-transaction confirmation server 200 (S240).

Thereafter, the before-transaction confirmation server 200 transmits the transaction confirmation signature to the payment service server 100 (S250).

Thereafter, the payment service server 100 transmits a transaction approval message to the affiliated store terminal 500 (S260).

Thereafter, the affiliated store terminal 500 receives an approval response message and performs the transaction.

Here, even in a case of using an electronic card that is housed in the user terminal 400, the same payment process is performed.

In this way, by confirming transaction details of an offline card transaction and verifying a confirmed result, an electronic signature transaction text can be prevented from being manipulated.

Further, due to hacking of the user terminal 400, even in a situation in which a transaction detail is maliciously changed or a situation in which malicious software is installed in the user terminal 400 through smishing, information may be safe from authentication information exposure and interception.

In this case, a security area (hereinafter, a secure element (SE)) that acquires the Key2 may generally exist in an USIM area or a security SD CARD 410 of the user terminal 400. The Key2 may be stored at the wearable device 600 or an accessory device 800 such as a dongle, a radio frequency identification (RFID) card, and an NFC card, as needed, and in this case, the Key2 may have a form that is transmitted with a non-contact method with a near field communication method.

Here, even in a case of using an electronic card that is housed in the user terminal 400, the same payment process is performed.

A security area (hereinafter, secure element (SE)) that acquires the Key2 may generally exist in a form of a USIM area or a security SD CARD, a dongle, a beacon, and an RFID chip of the user terminal 400.

The Key2 may be stored at the wearable device as needed, and in this case, the Key2 may have a form that is transmitted with a non-contact method with a near field communication method.

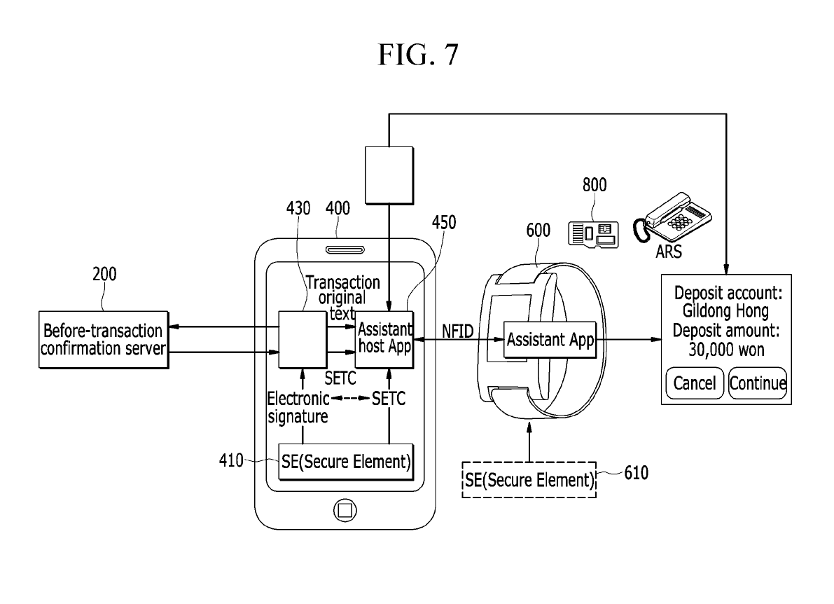

Referring to FIG. 7, for when the Key2 is stored in the wearable device 600 that is separated from the user terminal 400, interlocking for security authentication with the user terminal 400 and the wearable device 600 will be described.

By performing a payment card transaction App, the user terminal 400 may receive an encoded transaction full text together with the Key1 from the before-transaction confirmation server 200, acquire Key2 from a secure element (SE) that is stored in a USIM area of the wearable device 600 by performing near field communication with the wearable device 600 with a beacon or NFC method, decode the encoded transaction full text by coupling the Key2 and the Key1, and display the transaction full text in the user terminal 400 or the wearable device 600.

When an approval confirmation message is exposed in the user terminal 400 or the wearable device 600 using the before-transaction confirmation card payment App or assistant host App, a customer views a screen of the user terminal 400 or the wearable device 600 and performs or rejects a transaction confirmation signature.

In this way, in a case in which the Key2 is separated or independent from the user terminal 400, when the user terminal 400 which is a smart communication terminal is lost or stolen or when a foreign traveller loses or has a credit card stolen, the Key2 is stored at another wearable device 600 and thus security can be further enhanced.

The user terminal 400 may obtain the Key2 using an ARS phone instead of the wearable device 600.

In an exemplary embodiment of the process, there is a problem that a holding time for authentication occurs in a payment approval process.

Therefore, another exemplary embodiment for shortening a payment time will be described.

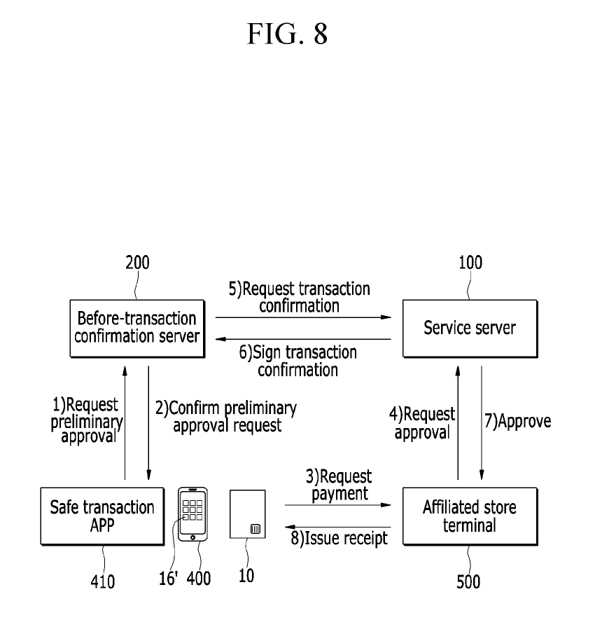

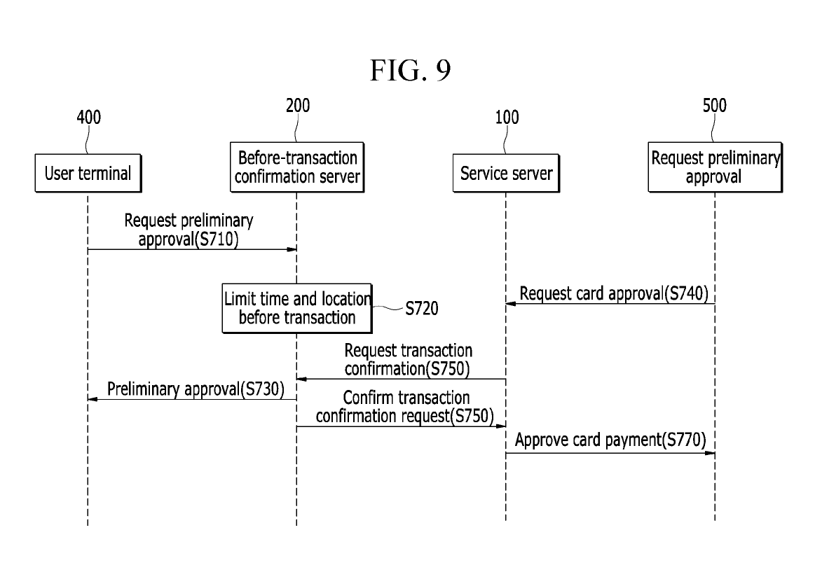

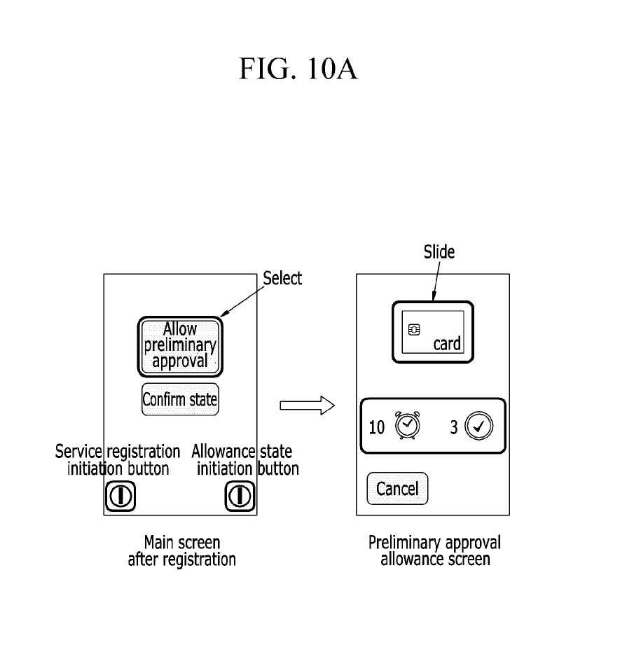

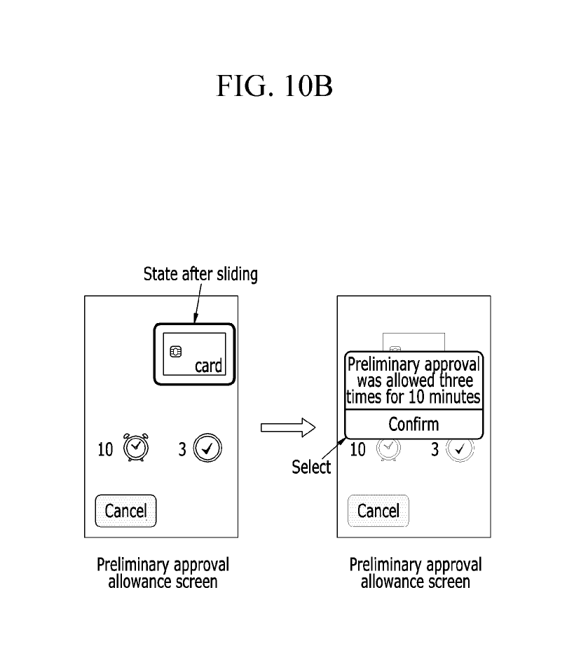

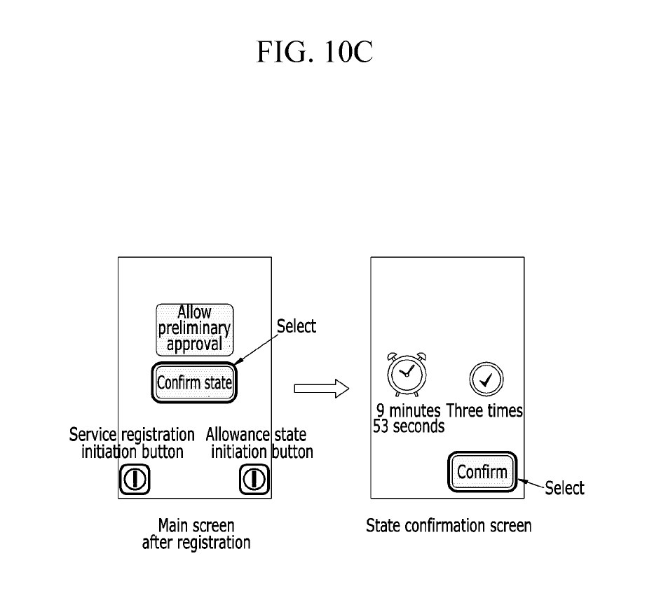

FIG. 8 is a schematic diagram illustrating a before-transaction confirmation card payment system according to another exemplary embodiment of the present invention, FIG. 9 is an operation flowchart illustrating a payment method of a before-transaction confirmation card according to another exemplary embodiment of the present invention, and FIGS. 10A to 100 are diagrams illustrating a preliminary approval service application screen of a before-transaction confirmation card payment system according to another exemplary embodiment of the present invention.

Referring to FIG. 8, a payment card operation system according to a second exemplary embodiment of the present invention includes a payment card issue agent terminal 300, a user terminal 400 of a foreign traveller, an affiliated store terminal 500 of a domestic affiliated store that sells a product, and a payment service server 100 that receives card issue information from the payment card issue agent terminal and that receives and approves payment information of the affiliated store terminal 500, similar to the first exemplary embodiment of the present invention, and thus a detailed description thereof is omitted and a before-transaction confirmation server 200, which is a dissimilar constituent element, or a preliminary confirmation server 200′ that may be used together therewith, will be described in detail.

The payment card operation system includes the before-transaction confirmation server 200 that receives and confirms a preliminary approval request of the user terminal 400 and that receives a transaction confirmation request from the payment service server to perform transaction confirmation.

In a before-transaction confirmation card payment system according to another exemplary embodiment of the present invention, the before-transaction confirmation server 200 may include a preliminary approval product recommendation unit 210 that recommends an affiliated store, a shopping mall, and a product that are subscribed to a before-transaction confirmation card payment service, a preliminary approval request receiving unit 230 that receives a preliminary approval request message that is encoded with Key2 in a security area within the user terminal 400 through a before-transaction confirmation card payment application of the user terminal 400 or through a separate wearable terminal 600 other than the user terminal 400 for a product that is recommended in the preliminary approval product recommendation unit 210, a Key2 storage unit 250 that previously stores the Key2 that is stored through the preliminary approval request receiving unit 230, and a preliminary approval request confirmation transmitting unit 270 that transfers a preliminary approval request confirmation message that confirms a preliminary approval request of a corresponding product from the user terminal 400.

Therefore, when requesting payment for a predetermined article at a predetermined location with the predetermined number at a predetermined time through the affiliated store terminal 500 by a payment card by visiting an offline store, if Key1 to be coupled to the Key2 is provided with various forms, the affiliated store terminal 500 may transmit a transaction confirmation request to the before-transaction confirmation server 200 for an approval request from the affiliated store terminal 400 of the payment service server 100 without a holding time for personal authentication and receive a transaction confirmation signature.

Further, by turning off the preliminary approval, the payment card may be used like a general card, and by setting the preliminary approval number to infinite, the payment card may be freely used without a holding time.

The before-transaction confirmation server 200 receives a preliminary approval request through a before-transaction confirmation card payment service application of the user terminal 400 for an affiliated store or an article of a before-transaction confirmation card payment service, limits a predetermined time and location for card payment, and performs preliminary approval.

Referring to FIG. 9, a payment method of a before-transaction confirmation card payment system according to another exemplary embodiment of the present invention having such a configuration is as follows.

First, the user terminal 400 requests preliminary approval to the before-transaction confirmation server 200 according to a user manipulation (S710).

Thereafter, the before-transaction confirmation server 200 receives a preliminary approval request from the user terminal 400 and confirms preliminary approval (S730).

In this case, the before-transaction confirmation server 200 receives a preliminary approval request from the user terminal 400, limits a predetermined time and location for card payment, and performs preliminary approval (S720).

Thereafter, the affiliated store terminal 500 requests card approval from the payment service server 100 according to a user's product purchase (S740).

The payment service server 100 receives the user's payment information approval request from the affiliated store terminal 500 and requests transaction confirmation from the before-transaction confirmation server 200 (S750).

Thereafter, the before-transaction confirmation server 200 confirms the transaction confirmation request, signs transaction confirmation, and transmits the transaction confirmation signature to the payment service server 100 (S760).

In this case, when a time and a location are not included in a before-transaction limitation, the before-transaction confirmation server 200 rejects transaction confirmation.

Thereafter, when the transaction confirmation signature is received, the payment service server 100 sends user transaction approval to the affiliated store terminal 500 (S770).

In another exemplary embodiment of the present invention, because payment approval is received in advance, a payment process can be more quickly performed, and due to a limitation such as a time and location, safer payment can be performed.

Hereinafter, a method of using a preliminary approval service of a before-transaction confirmation card payment system according to another exemplary embodiment of the present invention will be described in detail with reference to FIGS. 10A and 10C.

FIGS. 10A to 10C are diagrams illustrating a preliminary approval service application screen of a before-transaction confirmation card payment system according to another exemplary embodiment of the present invention.

As shown in FIG. 10A, a user may select preliminary approval allowance through an interface that is provided through the user terminal 400 and set a minute unit timer, set an allowance number, set an article, or set a location, thereby allowing preliminary approval.

As shown in FIG. 10B, by sliding a virtual payment card that is displayed in the display unit 430 of the user terminal 400, the preliminary approval may be allowed, and finally a content that the user preliminarily sets may be displayed in the user terminal 400.

As shown in FIG. 100, the user may allow preliminary approval before the transaction independently of payment, and confirm a preliminary approval state at a location requiring payment.

In some case, service registration may be initialized and an allowance state may be initialized.

When authentication has succeeded through the user terminal 400, the before-transaction confirmation server 200 may register a card using card registration information that is used for authentication, and in another case, the before-transaction confirmation server 200 provides a card registration screen, receives an input of card registration information according to a user's input manipulation, and transmits the card registration information to the before-transaction confirmation server 200.

As shown in FIG. 10B, the user terminal 400 may provide a card registration guide screen to be used for a before-transaction confirmation card payment service and complete card registration according to user confirmation.

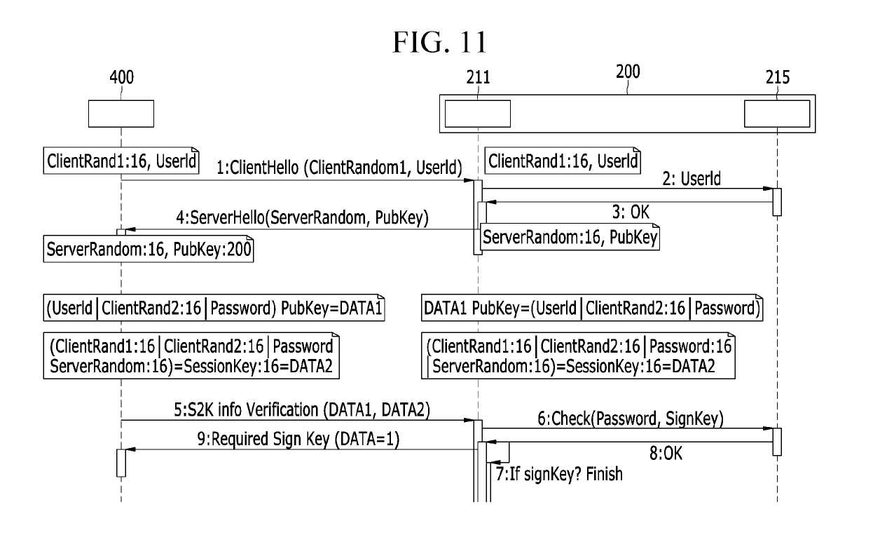

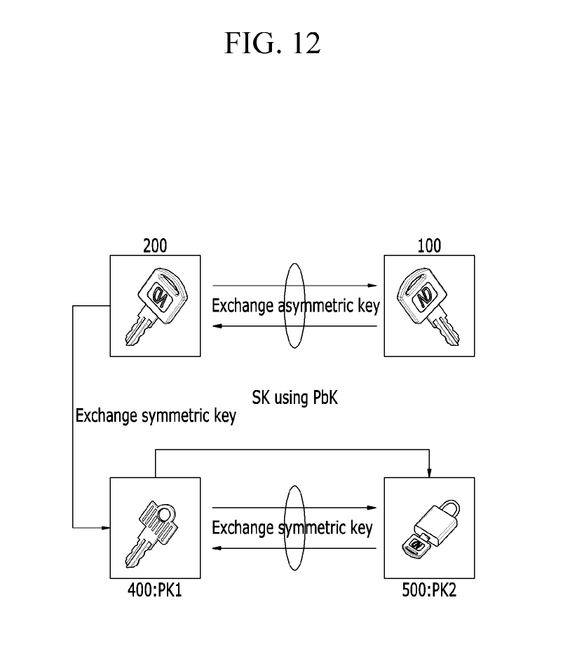

Hereinafter, security of a before-transaction confirmation card payment system according to another exemplary embodiment of the present invention will be described through a key exchange method between a user terminal and a before-transaction confirmation server of a before-transaction confirmation card payment system according to another exemplary embodiment of the present invention with reference to FIGS. 11 and 12.

FIG. 11 is an operation flowchart illustrating a key exchange method between a user terminal and a before-transaction confirmation server of a before-transaction confirmation card payment system according to another exemplary embodiment of the present invention, and FIG. 12 is a schematic diagram illustrating a security policy according to a key exchange method of a before-transaction confirmation card payment system according to another exemplary embodiment of the present invention.

As shown in FIG. 11, in a before-transaction confirmation card payment system according to another exemplary embodiment of the present invention, in order to use a before-transaction confirmation card payment service, when the user terminal 400 logs in through a before-transaction confirmation card payment application, UserId is transmitted to the before-transaction confirmation server 200, and the before-transaction confirmation server 200 may provide a PubKey, which is a random key.

The user terminal 400 encodes a password with the PubKey that is received from the before-transaction confirmation server 200 and forms a SessionKey.

In this case, the before-transaction confirmation server 200 encodes user terminal information and customer information DATA1 that is received from the payment service server 100 with a PubKey, which is a symmetric key, encodes a password with the PubKey, and stores a session key DATA2.

When a preliminary approval request from the user terminal 400 is combined with the encoded PubKey DATA1 and the session key DATA2 and is transmitted to the before-transaction confirmation server 200, the before-transaction confirmation server 200 confirms the stored password and signature key and requests the signature key from the user terminal 400.

The user terminal 400 encodes a signature key that is formed with a terminal OS, a terminal number UUID, user ID, and a password with the session key, and exchanges the signature key with the before-transaction confirmation server 200.

The before-transaction confirmation server 200 registers the stored user ID, password, and signature key, and transmits a preliminary approval state message.

In short, as shown in FIG. 12, a security module 410 of the user terminal 400 includes a private asymmetric key (PAKV) of a pair of asymmetric keys. The before-transaction confirmation server 200 includes a public asymmetric key PAKB from the asymmetric key pair. Therefore, the PubKey is matched to a private key of a security module.

In principle, an asymmetric key pair is a sole pair. However, when the number of users is actually very high, while an exchange possibility of authority is maintained very low, there is a possibility to have the same key pair several times. This danger may be set to 0 by using a unique supplementary symmetric key.

As shown in FIG. 12, when communication is started between the user terminal 400 and the before-transaction confirmation server 200, the before-transaction confirmation server 200 first generates a random number A. The random number is encoded in the before-transaction confirmation server 200 by PAKV with a method of acquiring an encoded random number A′ (A′=PAKV(A)). The random number is transmitted to the user terminal 400. The encoded random number A′ is decoded in the user terminal 400 by PAKB to enable to acquire an initial random number A.

Conversely, the user terminal 400 generates a random number B. The random number B is encoded using the PAKB. Therefore, an encoded random number B′ (B′=PAKB(B)) is obtained and is transmitted to the before-transaction confirmation server 200. The encoded random number B′ is decoded in the before-transaction confirmation server 200 by the PAKV to enable to acquire an initial random number B.

These two random numbers are combined with a method of generating a new random number and are used as a session key SK. The combination may be performed by simple concatenation, a function OR EXCLUSIVE of two numbers, or other appropriate combination.

A session key SK that is generated in this way is used for all security communication between the before-transaction confirmation server 200 and the user terminal 400.

Because it is regarded that it is impossible to know a private key that is included in a security module, the exemplary embodiment provides considerable security to a user. However, if the before-transaction confirmation server 200 may provide a determined number instead of a random number B, it is impossible to provide a random number A to the security module.

PAKB may be determined by a complex technical means with a similar method, but PAKV may be inferred. Therefore, a fact that each apparatus generates a random number and that the random numbers are encoded with an asymmetric key can prevent the apparatus from being deceived.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of paying by a card in which confirmation is available before a transaction, the method comprising:
receiving, by a payment service server, a user's payment information approval request from an affiliated store terminal upon paying by a payment card through the affiliated store terminal;
requesting, by the payment service server, transaction confirmation from a before-transaction confirmation server;
confirming, by the before-transaction confirmation server, the transaction by a transaction confirmation signature for a transaction confirmation request of the payment service server; and
approving, by the payment service server, a user's payment information approval request from the affiliated store terminal upon confirming the transaction from the before-transaction confirmation server,
wherein the transaction confirmation signature is performed with a manipulation of a virtual payment card in which the payment card is registered to interlock with a user terminal through a before-transaction confirmation card payment service application, and the user is authenticated through login authentication or card authentication before registering the payment card with the virtual payment card.

2. The method of claim 1, wherein the payment service server is at least one payment service server, and the payment card is at least one of a magnetic card, an IC chip card, and an App type of mobile card.

3. The method of claim 1, further comprising receiving, by the before-transaction confirmation server, the transaction confirmation signature from the user terminal,
wherein the receiving of the transaction confirmation signature comprises preliminary approval that is previously independently performed before paying by the payment card through the affiliated store terminal.

4. The method of claim 3, wherein the preliminary approval comprises a preliminary approval request in which the before-transaction confirmation server requests previously transaction confirmation from the user terminal, and
the preliminary approval is performed by limiting at least one of a time, a location, an article, and an execution number for the preliminary approval request.

5. The method of claim 1, wherein the confirming of transaction by a transaction confirmation signature comprises:
encoding, by the before-transaction confirmation server, the transaction confirmation request with a first key of the payment card and transmitting the encoded message to the user terminal;
decoding, by the user terminal, the received encoded message by combining the first key and a second key that is stored in a security area of the user terminal and displaying the decoded message in the user terminal; and
receiving, by the before-transaction confirmation server, a transaction confirmation signature of the user from the user terminal.

6. The method of claim 1, wherein the manipulation of a virtual payment card comprises reporting, when payment of the payment card in the affiliated store terminal is an illegal transaction that is not authenticated by the user, the payment of the payment card.

7. The method of claim 5, wherein the second key is provided through a wearable terminal or an accessory terminal that can perform near field communication with the user terminal or a phone automated response system (ARS).

8. The method of claim 1, wherein the manipulation of a virtual payment card comprises pushing the virtual payment card in one direction on a screen of the user terminal.

9. A card payment system in which confirmation is available before a transaction, the card payment system comprising:
an affiliated store terminal in which payment is performed by a payment card;
a payment service server that receives a payment information approval request of the payment card from the affiliated store terminal and that transmits approval of the payment information approval request to the affiliated store terminal;
a user terminal that stores a virtual payment card in which the payment card is interlocked through a before-transaction confirmation card payment service application; and
a before-transaction confirmation server that supports transaction confirmation by a manipulation of the virtual payment card of the user terminal before approval of the payment information approval request of the payment service server.

10. The card payment system of claim 9, wherein the payment service server is at least one payment service server, and the payment card is at least one of a magnetic card, an IC chip card, and an App type of mobile card.

11. The card payment system of claim 9, further comprising a first key of the payment card that encodes the transaction confirmation request and a second key that is stored in a security area of the user terminal that decodes the encoded transaction confirmation request that is received by the user terminal by combination with the first key,
wherein the second key is provided through a wearable terminal or an accessory terminal that can perform near field communication with the user terminal or a phone automated response system (ARS).
